(19) United States
(12) Patent Application Publication
(10) Pub. No.: US 2019/0060921 A1
(43) Pub. Date: Feb. 28, 2019

(54) SYSTEMS AND METHODS FOR PROVIDING A HYDRATION SYSTEM

(71) Applicant: Wade W. Henriksen, Las Vegas, NV (US)

(72) Inventor: Wade W. Henriksen, Las Vegas, NV (US)

(21) Appl. No.: 16/118,207

(22) Filed: Aug. 30, 2018

Related U.S. Application Data
(60) Provisional application No. 62/551,966, filed on Aug. 30, 2017.

(51) Int. Cl. B05B 1/20; B05B 15/60

(52) U.S. Cl. CPC B05B 1/20; B05B 15/60

(57) ABSTRACT

The present invention relates to systems and methods for producing mist and/or for otherwise providing a fluid to a desired location. More particularly, some implementations relate to a system that is configured to use a portable pumping system to spray a mist of water in a desired location. In some implementations, the pumping system includes one or more fluid containers, pressurizers, nozzles, and/or control mechanisms. In some cases, the system is configured to spray mist for a set period of time, to spray pulses of mist, to regulate mist flow based on ambient temperature and/or humidity, and/or to otherwise control or optimize mist flow. Other implementations are also described.

### BACKGROUND OF THE INVENTION

### 1. Related Applications

This application claims priority to U.S. Provisional Patent Application Ser. No. 62/551,966 (Attorney Docket No. 27892.2) filed Aug. 30, 2017, entitled “SYSTEMS AND METHODS FOR PROVIDING A HYDRATION SYSTEM”, which is incorporated herein by reference.

### 2. Field of the Invention

The present invention relates to systems and methods for producing mist and/or for otherwise providing a fluid to a desired location. More particularly, some implementations relate to a system that is configured to use a portable pumping system to spray a mist of water in a desired location. In some implementations, the pumping system is configured to spray mist for a set period of time, to spray pulses of mist, to regulate mist flow based on ambient temperature and/or humidity, and/or to otherwise control or optimize mist flow.

### 3. Background and Related Art

In many instances, when a person is in a hot environment and is away from an air-conditioned enclosure, it can be relatively easy for that person to become hot, dry, uncomfortable, and even sick. In an effort to cool themselves off, some people have been known to seek shade, fan themselves, pour water on themselves, wear wet clothing, and/or to otherwise take action to cool themselves off. While such methods are often effective at cooling a person off, such methods are not necessarily without their shortcomings. Indeed, when a person needs to stay in certain position (e.g., in a line at an amusement park), it can sometimes be difficult to find shade or a fan. Similarly, when a person pours water on themselves or wears clothing that is relatively wet, that person can feel uncomfortable, trying to decide if he or she truly does enjoy being wet over being hot.

Thus, while systems and methods currently exist that are used to cool people off, challenges still exist, including those listed above. Accordingly, it would be an improvement in the art to augment or even replace current techniques with other techniques.

### SUMMARY OF THE INVENTION

The present invention relates to systems and methods for producing mist and/or for otherwise providing a fluid to a desired location. More particularly, some implementations relate to a system that is configured to use a portable pumping system to spray a mist of water in a desired location. In some implementations, the pumping system includes one or more fluid containers, pressurizers, fluid conduits, nozzles, and/or control mechanisms. In some cases, the system is configured to spray mist for a set period of time, to spray pulses of mist, to regulate mist flow based on ambient temperature and/or humidity, and/or to otherwise control or optimize mist flow.

In some cases, the described pumping system is configured to be portable (e.g., being disposed in a bag, duffle bag, backpack, purse, fanny pack, sling, briefcase, suitcase, cart, substrate, skid, framework, and/or other suitable container and/or support). Accordingly, in some implementations, the described system can be easily moved from one location to another. Additionally, in accordance with some implementations, one or more portions of the described system (e.g., one or more spray nozzles, sections of fluid conduits, etc.) are configured to selectively couple to and decouple from a variety of objects. Indeed, in some implementations, one or more nozzles, sections of conduit, and/or other portions of the system comprise one or more clips, magnets, ties, wire ties, zip ties, straps, snaps, hook and loop fasteners, hooks, clasps, rings, mechanical engagements, frictional engagements, and/or other suitable engagements that are configured to allow one or more portions of the system (e.g., the nozzles, the fluid conduits, etc.) to be selectively coupled to and decoupled from any suitable object. In this regard, the various portions of the described system can be configured to selectively couple to and decouple from any suitable object, including, without limitation, any suitable trellis, swing, seat, umbrella, golf cart, ATV, utility vehicle, vehicle, bicycle, wagon, carriage, awning, shade sail, canopy, tent, eave, structure, chair, table, framework, hammock, tree, stand, hat, article of clothing, walking stick, cane, and/or other suitable object.

While the methods and systems of the present invention may be particularly useful for providing a mist for the purpose of providing cooling, those skilled in the art will appreciate that the described systems and methods can be used in a variety of different applications and in a variety of different areas of manufacture. Indeed, in addition to (or in place of) providing mist, some implementations of the described system are configured to provide a stream of fluid (e.g., for drinking, hosing an object off, and/or any other suitable purpose), multiple streams of fluid (e.g., for providing a shower), and/or for any other suitable purpose.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above-recited and other features and advantages of the present invention are obtained, a more particular description of the invention will be rendered by reference to specific embodiments thereof, which are illustrated in the appended drawings. Understanding that the drawings are not necessarily drawn to scale or in proper proportion, and that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a schematic view of a portable hydration system in accordance with a representative embodiment of the invention;

FIGS. 2A-2C depict different views of some embodiments of the hydration system;

FIGS. 3A-3E depict various embodiments of the hydration system being used in a variety of environments;

FIG. 4 illustrates a representative system that provides a suitable operating environment for use with some embodiments of the hydration system; and

FIG. 5 illustrates a representative embodiment of a networked system that provides a suitable operating environment for use with some embodiments of the described hydration system.

### DETAILED DESCRIPTION OF THE INVENTION

The present invention relates to systems and methods for producing mist and/or for otherwise providing a fluid to a desired location. More particularly, some embodiments relate to a system that is configured to use a portable pumping system to spray a mist of water in a desired location. In some embodiments, the pumping system is configured to spray mist for a set period of time, to spray pulses of mist, to regulate mist flow based on ambient temperature and/or humidity, and/or to otherwise control or optimize mist flow.

The following disclosure is grouped into two subheadings, namely “HYDRATION SYSTEM” and “REPRESENTATIVE OPERATING ENVIRONMENT.” The utilization of the subheadings is for convenience of the reader only and is not to be construed as being limiting in any sense.

### HYDRATION SYSTEM

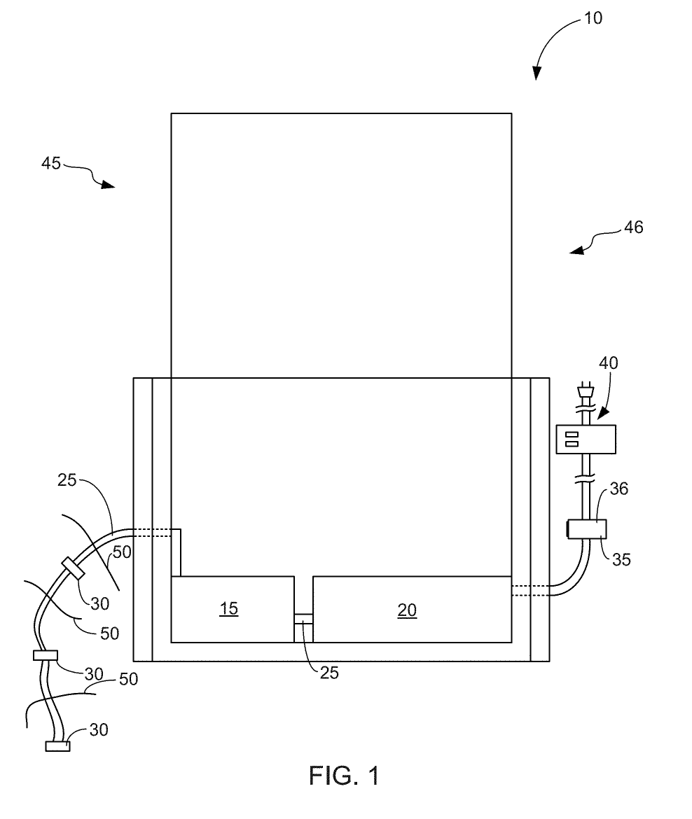

In accordance with some embodiments, the described portable hydration system can comprise any suitable component that allows it to provide fluid as a mist and/or in any other suitable form to a desired location. In accordance with some embodiments, however, FIG. 1 shows that the portable hydration system 10 comprises one or more fluid pressurizers 15, fluid containers 20, conduits for channeling fluid 25, nozzles 30, control systems 35, power sources 40, carrying systems 45, and/or connecting mechanisms 50.

With respect to the pressurizer 15, the hydration system 10 can comprise any suitable mechanism that is configured to force and/or draw one or more fluids from one or more fluid containers 20 and to force such fluids to one or more desired locations (e.g., via one or more nozzles 30). By way of non-limiting example, the pressurizer can comprise one or more AC pumps, DC pumps, peristaltic pumps, positive displacement pumps, negative displacement pumps, piezoelectric pumps, manual pumps, motorized pumps, piston pumps, fixed displacement piston pumps, axial piston pumps, radial piston pumps, reciprocating pumps, plunger pumps, roots blowers, pumps that are configured to increase pressure within the fluid container to thereby force fluid from the container, centrifugal pumps, rotary pumps, vane-type pumps, diaphragm pumps, multi-stage pumps, variable speed pumps, wringers (e.g., one wheel that pinches a portion of the container against another wheel or other object in which at least one wheel is configured to roll to force fluid from the container), and/or any other suitable mechanism that is capable or forcing and/or drawing fluid from the fluid container. Indeed, in some embodiments, the pressurizer comprises one or more DC pumps (e.g., a diaphragm pump of any suitable amperage (e.g., between about 0.1 Amps and about 100 Amps (or any subrange thereof), such as a diaphragm pump that operates at about 3 Amps ±1.5 Amps). The pressurizer (e.g., pump) can also operate at any suitable pressure (e.g., between about 1 psi and about 1,000 psi, or any subrange thereof). Indeed, in some embodiments, the pressurizer operates at about 100 psi±50 psi.

The pressurizer 15 can be configured to force and/or draw fluid from the fluid container 20 at any suitable rate that allows the system 10 to provide a suitable amount of fluid (e.g., as a mist or otherwise) to one or more desired locations. Indeed, in some embodiments, the pressurizer (e.g., a DC or other suitable pump) is configured to draw and/or force fluid from the container at between about 2 milliliters (ml) and about 20 liters (L) per minute, and/or at any subrange thereof. For instance, some embodiments of the pressurizer are configured to draw and/or force fluid from the container at a rate of between about 0.1 L and about 10 L per minute (or any subrange thereof). Indeed, in some embodiments, the pressurizer is configured to draw and/or force fluid from the container (e.g., through one or more nozzles 30) at a rate of between about 1 L and about 6 L per minute (e.g., about 4 L per minute±2 L). In this regard, while some embodiments of the pressurizer are configured to draw and/or force fluid from the container at any of aforementioned rates, in some embodiments, one or more nozzles 30, pressure regulators (not shown), valves (not shown), conduits, obstructions, and/or other components of the system may prevent mist (and/or another form of fluid) from being expelled from the hydration system at such rates. Indeed, in some embodiments, the nozzles (and/or another portion of the system) limit the rate at which fluid leaves the system—thus allowing the system to operate for a relatively long period of time, at a relatively high pressure to provide a desired mist (or other form of fluid release) without requiring the container to be constantly refilled.

Although some embodiments of the described system are configured to draw water from relatively large water source (e.g., a hose, tap, stream, body of water, etc.), some other embodiments optionally comprise one or more containers 20 that are configured to hold an amount of fluid. In such embodiments, the system 10 can comprise any suitable number of fluid containers (e.g., 1, 2, 3, 4, 5, 6, 7, 8, 9, 10, or more) that allow the system to provide fluid from the containers to a desired location. Indeed, in some embodiments, the system comprises one or more containers that are each configured to hold: potable water; non-potable water; one or more juices, sodas, beverages, electrolytes, ice, soaps, detergents, essential oils, fragrances, and/or coloring agents; and/or other suitable fluids. Thus, in some embodiments, the system may provide a fluid for dispersal to the ambient environment (e.g., as a mist or otherwise) while allowing a separate fluid (e.g., a juice, soda, soap, etc.) to be used for another purpose (e.g., drinking, showering, hosing an item off, washing hands, etc.).

The container 20 can have any suitable characteristic that allows it to perform its intended functions. Although some embodiments of the container are relatively rigid, in some other embodiments, the container is relative flexible. Indeed, in some embodiments, the container comprises one or more bladders and/or bags that are relatively flexible. Additionally, while some embodiments of the container are configured to be used only one time (e.g., being punctured and/or otherwise opened for a single use, but not necessarily being refillable), some other embodiments of the container are configured to be reusable (e.g., comprising one or more closures that can be selectively opened and/or closed).

While the container 20 can hold any suitable amount of fluid that allows the system 10 to function as intended, in some embodiments, the container is configured to hold between about 5 ml and about 100 L of fluid (or any subrange thereof). Indeed, in some embodiments, the container holds between about 0.5 L and about 6 L (e.g., about 3 L±2 L) of fluid (or any subrange of any of the foregoing ranges).

With respect now to the fluid conduits 25, the system 10 can comprise any suitable conduits that allow fluid be channeled from the container 20 to one or more nozzles 30, pores, and/or other orifices. Indeed, in some embodiments, the system comprises one or more conduits that are configured to draw fluid from the fluid container 20 to the pressurizer 15 and/or to one or more conduits that are configured to channel fluid from the pump and/or the container to one or more nozzles 30, tubes, and/or orifices.

The fluid conduits 25 can further be any suitable length, including, without limitation, between about 0.1 centimeters (cm) (e.g., simply comprising a single nozzle) and about 100 meters (m) or any subrange thereof. Indeed, in some embodiments, the fluid conduits are between about 20 cm and about 2.5 m (or any subrange thereof). Additionally, as described below, in some embodiments, a length of the fluid conduits is selectively adjustable as one or more lengths of conduit are added to and/or removed from the system 10.

The fluid conduits (and/or the container 20) can comprise any suitable material that allows them to function as described herein, including, without limitation, one or more types of plastics, polymers, rubbers, glasses, polyethylenes, copolymers, metals, alloys, dimethyl terephthalates, biaxially-oriented polyethylene terephthalates (e.g., MYLAR™, MELINEX™, HOSTAPHAN™, and/or other similar materials), nylons, acetyls, foils, metals, polyamides, acrylonitrile butadiene styrenes, polyvinyl chlorides, polycarbonates, polyesters, polyethylenes, high-density polyethylenes, polypropylenes, acrylonitrile butadiene styrenes, polyurethanes, synthetic materials, natural materials, and/or other suitable materials. Indeed, in some embodiments, the conduits and/or the container comprise one or more BPA-free materials (e.g., 2,2,4,4-tetramethyl-1,3-cyclobutanediol, 1,4-cyclohexanedimethanol, dimethyl terephthalate, rubber, etc.).

With respect to the nozzles 30, the system 10 can comprise any suitable number of nozzles, including, without limitation, 1, 2, 3, 4, 5, 6, 7, 8, 9, 10, or more. Indeed, in some embodiments, the system is configurable such that one or more nozzles and/or sections of conduit 25 (e.g., as mentioned above) can be selectively added to, and/or be removed from, the system (e.g., via one or more quick-connect mechanisms, threaded couplings, frictional engagements, mechanical engagements, couplings, and/or other suitable mechanisms). Accordingly, in some embodiments, the number of nozzles, the length of the conduits, the space between nozzles, the number of containers, and/or a variety of other characteristics of the system can readily be modified to tailor the system to specific needs.

The system 10 can comprise any suitable type of nozzle 30 that allows the system to disperse one or more fluids. Some non-limiting examples of nozzles include one or more misting nozzles, spray nozzles, orifices, valves, shower nozzles/heads, pores, soaker hose pores, adjustable nozzles, metal nozzles, plastic nozzles, nozzles comprising any suitable material, fog nozzles, hose nozzles, multi-function nozzles, and/or other suitable openings, sprayers, jets, spigots, and/or other nozzles through which fluid may flow. Indeed, in some embodiments, the system comprises one or more misting nozzles. In some other embodiments, the system comprises multiple different types of nozzles, and/or adjustable nozzles that allow the system to provide fluid in multiple manners (e.g., as a mist, stream, spray, fog, burst, etc.).

With respect to the control system 35, the system can comprise any suitable system that is capable of starting, stopping, and/or varying the flow of one or more fluids from the system. Indeed, in some embodiments, the system comprises one or more switches, valves, sensors (e.g., humidity sensors, thermometers, wind speed sensors, light sensors, speedometers, and/or other suitable sensors), processors (e.g., as discussed below in the section entitled Suitable Operating Environment), timers, and/or other components that can be used to start, stop, vary, and/or otherwise determine when and/or how fluid flows from the system. In one example, the system comprises a switch that is configured to turn on and off and/or otherwise vary function of the pressurizer 15, to open and/or close one or more valves, and/or to otherwise cause fluid to be forced from the system (e.g., via one or more nozzles 30 or otherwise). In this regard, the switch can comprise any suitable switch, including, without limitation, one or more push buttons, toggles, limits, single pole single throws, single pole double throws, double pole single throws, double pole double throws, timer switches, touch screen controls, programmable controls, and/or other suitable switches. Indeed, in some embodiments, the control system comprises one or more timer switches that regulate the amount of time that the system delivers fluid from the system.

Indeed, in some embodiments, the system 10 comprises one or more switches and/or control systems that are configured to release fluid from the system (e.g., as a mist or otherwise) for a set period of time, in bursts, at a varied rate, at specific programmed times, in accordance with a program, based on an ambient temperature (e.g., as determined by a thermometer, weather report, and/or other suitable source), based on temperature of a user (e.g., a thermometer and/or other suitable sensor measuring the user's temperature), based on calories burned by one or more users, based on a speed of a user (e.g., a user's walking/jogging/running speed, treadmill speed, stationary bike speed, etc.), based on an ambient light level, based on an ambient humidity level, in accordance with a preset program, at a variable rate controlled by a user and/or program, and/or in any other suitable manner. Indeed, FIG. 1 shows an embodiment in which the control mechanism 25 comprises a toggle switch 36 that is configured to turn the pressurizer 15 (e.g., pump) on and off as the switch is engaged and disengaged. In some other embodiments, however, the control mechanism is configured to increase fluid flow as an ambient temperature increases and to decrease fluid flow as the ambient temperature decreases.

With respect to the power source 40, the system 10 can comprise any suitable power source that allows the system to function as described herein. Some non-limiting examples of power sources include, but are not limited to, one or more batteries, solar cells, cigarette lighter sockets, AC power sockets, DC power sockets, generators, nuclear reactors, and/or other suitable power sources. Indeed, in some embodiments, the system is configured to be plugged into an electrical grid (e.g., the mains) (see e.g., FIG. 1). In some other embodiments, the system is configured to be plugged into (directly or indirectly) a cigarette lighter socket in a vehicle. In yet other embodiments, the system is battery powered. In some other embodiments, the system is configured to plug into a USB receptacle to receive power (and/or to be controlled). In still other embodiments, the system comprises one or more solar cells and/or batteries (e.g., allowing the system to be used “off the grid”). In still other embodiments, the system is readily configurable to receive power from a variety of sources (e.g., having one or more adapters, plugs, inputs, etc.). Additionally, in some embodiments, the system is configured to provide power (e.g., via one or more sockets, USB sockets, etc.) to one or electrical devices (e.g., phones, laptops, watches, and/or other devices that are electrically operated).

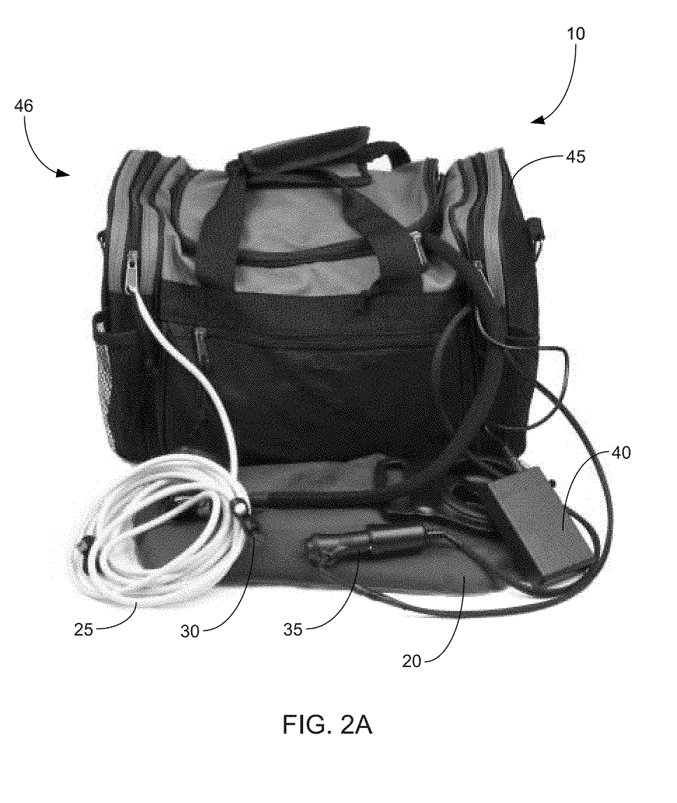

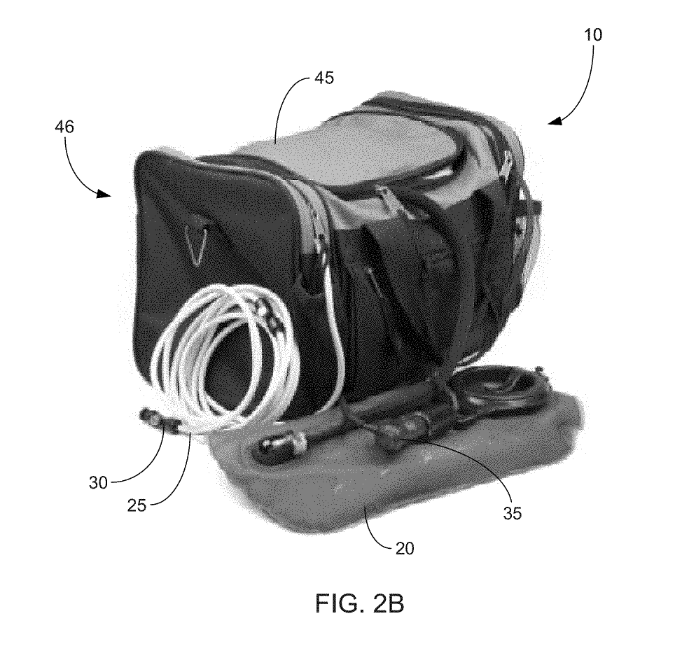

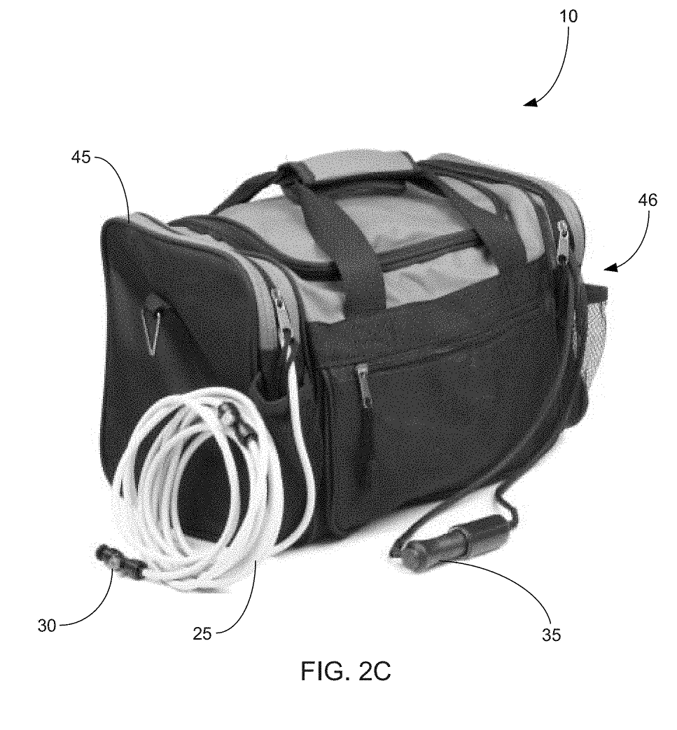

Some embodiments of the system 10 are optionally housed in, held or supported by, and/or otherwise used in conjunction with one or more carrying systems 45 that allow the system to be transported relatively easily. In this regard, the carrying system can comprise any suitable duffle bag, bag, backpack, sling, fanny pack, suitcase, travel bag, satchel, purse, cart, tote, bucket, box, container, substrate, carrying case, substrate, skid, framework, structure, and/or other suitable object that can be used to support one or more portions of the system. Indeed, in some embodiments, the system comprises one or more bags that are configured to hold the pressurizer 15, the container 20, the control mechanism 35, and/or any other suitable portion of the system. By way of non-limiting illustration, FIGS. 1-2C show some embodiments in which the carrying system 45 comprises a duffle bag 46.

While the carrying system 45 can comprise any suitable component, in some embodiments, the carrying system comprises one or more: separate compartments for various portions of the system (e.g., a conduit compartment, a pump compartment, a container compartment, etc.); handles; shoulder straps; straps, belts, hooks, carabiners, and/or other coupling mechanisms that are configured to couple the carrying system to a device or other object); structures for holding the nozzles 30 and/or conduits (e.g., a framework, expandable scaffolding, scaffolding, umbrella frame, poles, and/or other suitable structure that can be carried in and/or with the system); displays (e.g., displaying fluid levels, power levels, temperatures, and/or any other suitable information); and/or any other suitable component. By way of non-limiting illustration, FIGS. 1-2C show some embodiments in which the carrying system 45 (e.g., duffle bag 46) comprises a variety of compartments to hold various portions of the system 10.

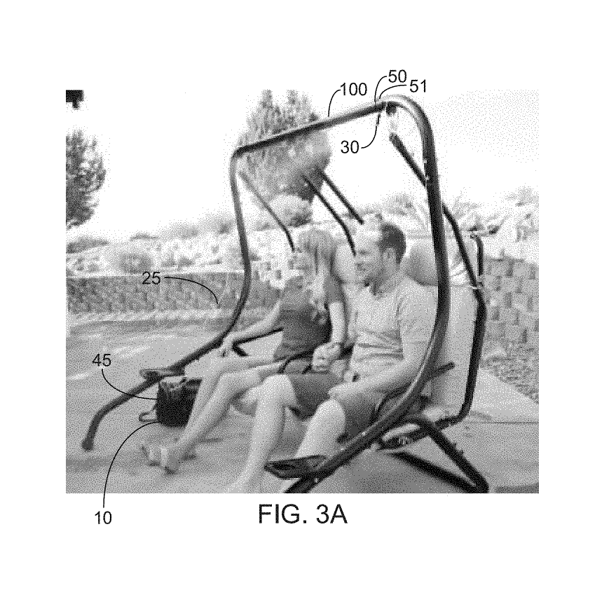

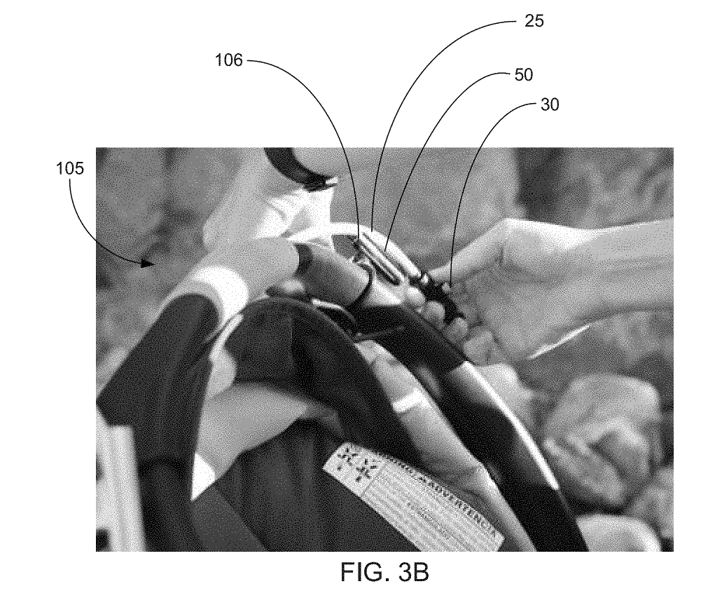

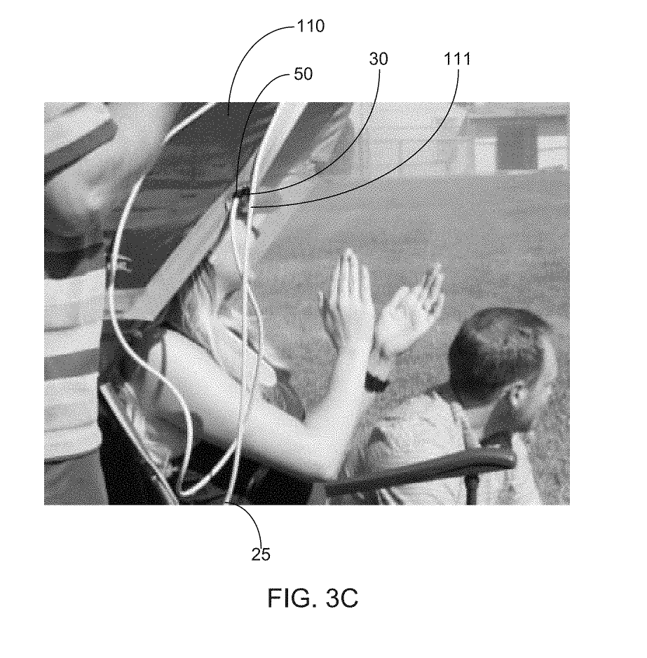

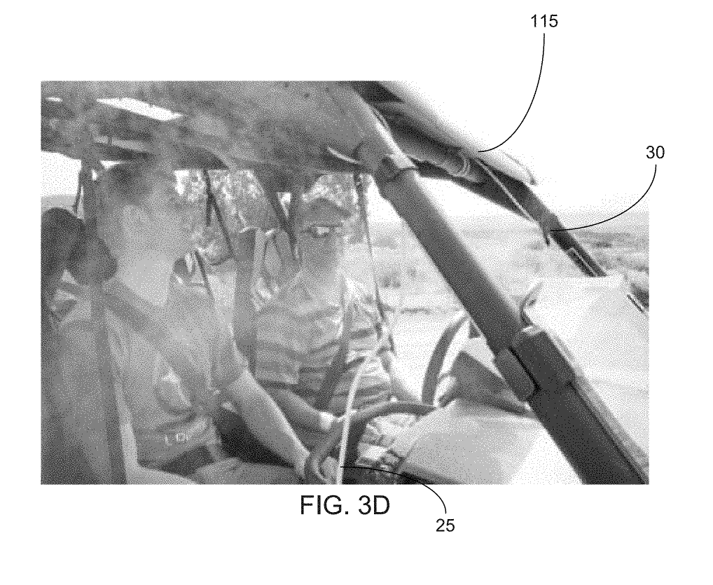

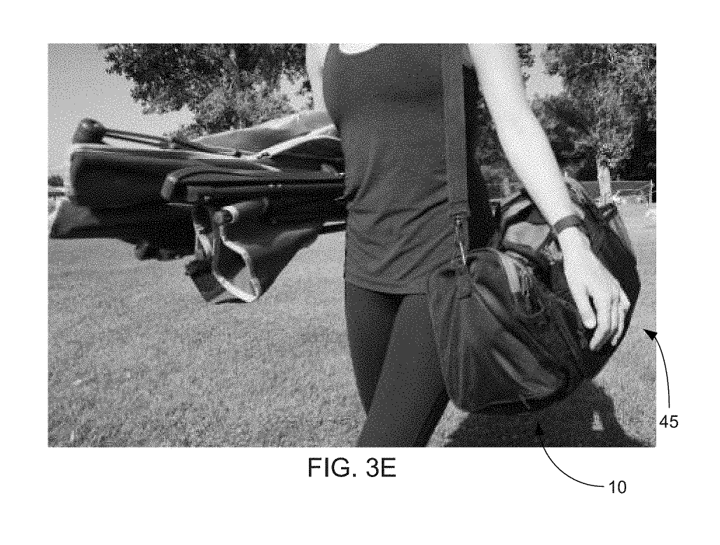

With respect now to the connecting mechanism 50, the system 10 optionally comprises any suitable component or components that allow one or more portions of the system (e.g., the conduits 25, the nozzles 30, and/or any other suitable component) to be coupled (permanently or removably) to one or more objects. Indeed, in some embodiments, one or more nozzles, sections of conduit, and/or other portions of the system comprise one or more clips, clamps, catches, magnets, magnetic closures, ties, wire ties, zip ties, straps, strings, bindings, snaps, hook and loop fasteners, hooks, clasps, rings, mechanical engagements, frictional engagements, carabiners, and/or other suitable engagements that are configured to allow one or more portions of the system (e.g., the nozzles, the fluid conduits, etc.) to be selectively coupled to and decoupled from any suitable object. Indeed, in some embodiments, one or more sections of the conduit comprise one or more flexible wires that can allow the conduit to be bent and to retain its shape until it is bent again. In another example, FIG. 3A shows that in some embodiments, the conduit 25 is coupled to an object (e.g., a swing 100 or bar) via one or more wire ties, straps, and/or other suitable couplers 51. In another example, FIG. 3B shows that, in some embodiments, the conduit 25 is coupled to a stroller (e.g., a stroller 105) via a clip 106. Additionally, FIG. 3C shows an embodiment in which conduits 25 are configured to be clamped to an object (e.g., a parasol 110 and/or any other suitable object) via a spring-loaded clip 111.

The various portions of the described system 10 (e.g., the conduits 25, the nozzles 30, etc.) can be configured to selectively couple to and decouple from any suitable object, including, without limitation, any suitable trellis, swing, seat, umbrella, golf cart, stroller, ATV, UTV, vehicle, bike, wagon, trailer, truck bed, carriage, awning, shade sail, canopy, tent, eave, structure, chair, table, lounge chair, framework, hammock, tree, stand, hat, article of clothing, walking stick, cane, and/or other suitable object. Indeed, FIGS. 3A-3D show (as discussed above) that in some embodiments, the conduit 25 and/or nozzles 30 couple to a swing 100, stroller 105, parasol 110, vehicle 115, and/or any other suitable object.

The described system 10 can be varied in any suitable manner. Indeed, in some embodiments, the system is configured to provide a mist for cooling a user and as well as fluid for the user to drink. In such embodiments, the system can comprise any suitable component that allows it to function as intended. Indeed, in some embodiments, the system comprises two or more pumps and two or more fluid containers. In some other embodiments, however, the system comprises one pump, one or more containers, and one or more valves (e.g., bite valves, cock valves, solenoid valves, electronically controlled valve, and/or other suitable valves that are configured to allow the system to provide one or more fluids in one or different manners (e.g., as a mist, as a stream for drinking, etc.).

In another example, some embodiments of the system 10 comprise two or more containers 20 and are configured to mix the contents of the containers. For instance, in some embodiments, a first container is configured to hold one or more soaps, detergents, flavoring agents, drinks, ice, and/or other suitable materials and a second container is configured to contain water, one or more drinks, and/or any other suitable material(s). In some such embodiments, the contents of the first container are configured to mix with the contents of the second container when fluid is forced from the system, on demand (e.g., as flavor and/or soap shots), via one or more venturis, in accordance with a program, when a valve is actuated, and/or in any other suitable manner. Accordingly, in some embodiments in which the system is being used as a shower, a user and/or program can use the system to introduce soap into the spray and then stop soap from being introduced into the spray so as to provide a rinse. In another embodiment, a user and/or program can cause the system to provide a flavor shot into a drink.

As another example, although some embodiments of the container 20 and/or the conduits 25 are not provided with any form or insulation, in some other embodiments, the container 20 and/or the conduits are housed in, coated with, and/or otherwise thermally insulated by one or more insulating materials. In this regard, the container and/or conduits can be coated with, housed by, and/or otherwise used with any suitable insulating materials, including, without limitation, one or more coatings, sleeves, pockets, wraps, dividers, and/or other objects that are configured to coat, house, and/or otherwise be used with the container and/or conduits, wherein such materials include one or more thermally insulating polycholorprenes, foams, styrofoams, open celled foams, closed cell foams, rubber foams, rubbers, mineral wools, glass wools, polyethylenes, polymers, plastics, cellular glasses, silica aerogels, and/or other suitable materials that are configured to insulate fluid contained within the container and/or the fluid conduits.

In some embodiments, the described system further includes one or more cooling apparatus (e.g., refrigerants, refrigerators, coolants, etc.) that are configured to cool fluid in the container 20.

As yet another example of a suitable variation, in some embodiments, the system 10 comprises one or more containers 30 that are configured to hold ice and/or any other suitable coolant, in some such embodiments, the system is configured to run fluid over, through, or past the ice and/or other coolant, without actually introducing the ice and/or other coolant into the fluid.

In addition to the aforementioned feature, the described hydration system 10 can have any other feature. Indeed, in some embodiments, the described system is relatively light weight—thus allowing it to be used to provide cooling and/or hydration while walking, backpacking, hiking, camping, exercising, traveling, and/or a wide variety of other purposes. For instance, FIG. 3E shows that, in some embodiments, it can easily be carried (e.g., for picnics and/or any other suitable purpose).

As an additional feature, in some embodiments, the carrying system 45 is configured to hold a wide variety of other objects in addition to the described hydration system (e.g., as shown in FIG. 3E).

The various portions of the described system 10 can be made in any suitable manner. In this regard, some non-limiting examples of methods for making the described hydration system include coupling various components together (e.g., via frictional, mechanical, and/or other coupling mechanisms), soldering, electrically connecting, machining, etching, cutting, drilling, grinding, shaping, stamping, plaining, molding, extruding, smoothing, buffing, polishing, sewing, and/or otherwise forming various pieces and assembling the described hydration system 10.

Thus, as discussed herein, embodiments of the present invention relate to systems and methods for producing mist and/or for otherwise providing a fluid to a desired location. More particularly, some embodiments relate to a system that is configured to use a portable pumping system to spray a mist of water in a desired location. In some embodiments, the pumping system is configured to spray mist for a set period of time, to spray pulses of mist, to regulate mist flow based on ambient temperature and/or humidity, and/or to otherwise control or optimize mist flow.

### REPRESENTATIVE OPERATING ENVIRONMENT

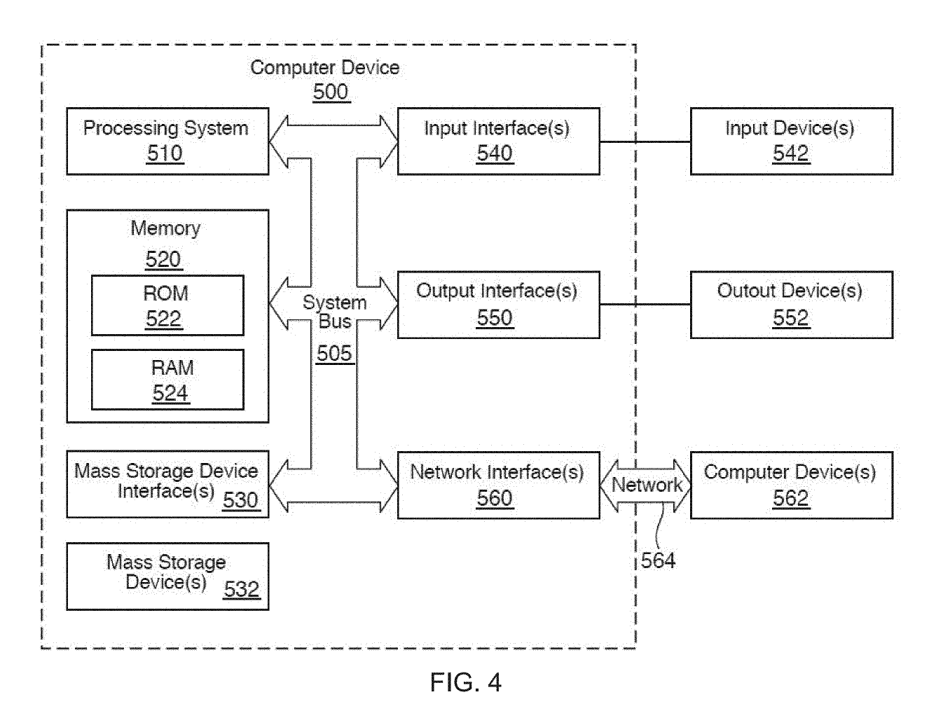

As mentioned, some embodiments of the described system 10 are configured to be operated (at least in part) by one or more special-purpose computers (e.g., computers configured to control the hydration system 10, fluid flow, fluid mixtures, etc.) and/or general purpose computers. Indeed, the described systems and methods can be used with or in any suitable operating environment and/or software. In this regard, FIG. 4 and the corresponding discussion are intended to provide a general description of a suitable operating environment in accordance with some embodiments of the described systems and methods. As will be further discussed below, some embodiments embrace the use of one or more processing (including, without limitation, micro-processing) units in a variety of customizable enterprise configurations, including in a networked configuration, which may also include any suitable cloud-based service, such as a platform as a service or software as a service.

Some embodiments of the described systems and methods embrace one or more computer readable media, wherein each medium may be configured to include or includes thereon data or computer executable instructions for manipulating data. The computer executable instructions include data structures, objects, programs, routines, or other program modules that may be accessed by one or more processors, such as one associated with a general-purpose processing unit capable of performing various different functions or one associated with a special-purpose processing unit capable of performing a limited number of functions.

Computer executable instructions cause the one or more processors of the enterprise to perform a particular function or group of functions and are examples of program code means for implementing steps for methods of processing. Furthermore, a particular sequence of the executable instructions provides an example of corresponding acts that may be used to implement such steps.

Examples of computer readable media (including non-transitory computer readable media) include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing unit.

With reference to FIG. 4, a representative system includes computer device 500 (e.g., a monitoring system or other unit), which may be a general-purpose or (in accordance with some presently preferred embodiments) special-purpose computer. For example, computer device 500 may be a personal computer, a notebook computer, a PDA or other hand-held device, a workstation, a digital pen, a minicomputer, a mainframe, a supercomputer, a multi-processor system, a network computer, a processor-based consumer device, a cellular phone, a tablet computer, a smart phone, a feature phone, a smart appliance or device, a control system, or the like.

Computer device 500 includes system bus 505, which may be configured to connect various components thereof and enables data to be exchanged between two or more components. System bus 505 may include one of a variety of bus structures including a memory bus or memory controller, a peripheral bus, or a local bus that uses any of a variety of bus architectures. Typical components connected by system bus 505 include processing system 510 and memory 520. Other components may include one or more mass storage device interfaces 530, input interfaces 540, output interfaces 550, and/or network interfaces 560, each of which will be discussed below.

Processing system 510 includes one or more processors, such as a central processor and optionally one or more other processors designed to perform a particular function or task. It is typically processing system 510 that executes the instructions provided on computer readable media, such as on the memory 520, a magnetic hard disk, a removable magnetic disk, a magnetic cassette, an optical disk, or from a communication connection, which may also be viewed as a computer readable medium.

Memory 520 includes one or more computer readable media (including, without limitation, non-transitory computer readable media) that may be configured to include or includes thereon data or instructions for manipulating data, and may be accessed by processing system 510 through system bus 505. Memory 520 may include, for example, ROM 522, used to permanently store information, and/or RAM 524, used to temporarily store information. ROM 522 may include a basic input/output system (“BIOS”) having one or more routines that are used to establish communication, such as during start-up of computer device 500. RAM 524 may include one or more program modules, such as one or more operating systems, application programs, and/or program data.

One or more mass storage device interfaces 530 may be used to connect one or more mass storage devices 532 to the system bus 505. The mass storage devices 532 may be incorporated into or may be peripheral to the computer device 500 and allow the computer device 500 to retain large amounts of data. Optionally, one or more of the mass storage devices 532 may be removable from computer device 500. Examples of mass storage devices include hard disk drives, magnetic disk drives, tape drives, solid state mass storage, and optical disk drives.

Examples of solid state mass storage include flash cards and memory sticks. A mass storage device 532 may read from and/or write to a magnetic hard disk, a removable magnetic disk, a magnetic cassette, an optical disk, or another computer readable medium. Mass storage devices 532 and their corresponding computer readable media provide nonvolatile storage of data and/or executable instructions that may include one or more program modules, such as an operating system, one or more application programs, other program modules, or program data. Such executable instructions are examples of program code means for implementing steps for methods disclosed herein.

One or more input interfaces 540 may be employed to enable a user to enter data (e.g., initial information) and/or instructions to computer device 500 through one or more corresponding input devices 542. Examples of such input devices include a keypad, a keyboard and/or alternate input devices, such as a thermometer, a moisture sensor, a humidity sensor, a light sensor, a speedometer, a calorie sensor, a heartrate sensor, pin pad, touch screen, mouse, trackball, light pen, stylus, and/or other input devices. Similarly, examples of input interfaces 540 that may be used to connect the input devices 542 to the system bus 505 include a serial port, a parallel port, a game port, a universal serial bus (“USB”), a firewire (IEEE 1394), a wireless receiver, a video adapter, an audio adapter, a parallel port, a wireless transmitter including, without limitation, interface satellite feeds, and/or any other suitable interface.

One or more output interfaces 550 may be employed to connect one or more corresponding output devices 552 to system bus 505. Examples of output devices include a monitor or display screen, a speaker, a wireless transmitter, a printer, and the like. A particular output device 552 may be integrated with or peripheral to computer device 500. Examples of output interfaces include a video adapter, an audio adapter, a parallel port, and the like.

One or more network interfaces 560 enable computer device 500 to exchange information with one or more local or remote computer devices, illustrated as computer devices 562, via a network 564 that may include one or more hardwired and/or wireless links. Examples of the network interfaces include a network adapter for connection to a local area network (“LAN”) or a modem, a wireless link, or another adapter for connection to a wide area network (“WAN”), such as the Internet. The network interface 560 may be incorporated with or be peripheral to computer device 500.

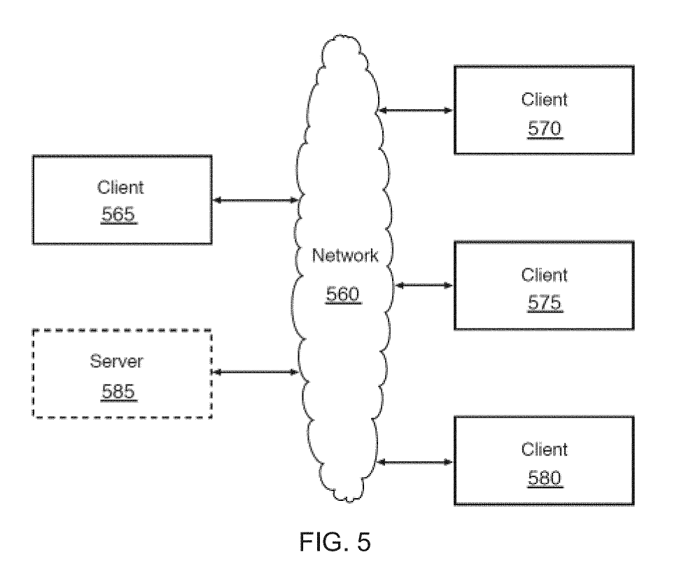

In a networked system, accessible program modules or portions thereof may be stored in a remote memory storage device. Furthermore, in a networked system computer device 500 may participate in a distributed computing environment, where functions or tasks are performed by a plurality networked computer devices. While those skilled in the art will appreciate that the described systems and methods may be practiced in networked computing environments with many types of computer system configurations, FIG. 5 represents an embodiment of a portion of the described systems in a networked environment that includes clients (565, 570, 575, etc.) connected to a server 585 via a network 560. While FIG. 5 illustrates an embodiment that includes 3 clients connected to the network, alternative embodiments include at least one client connected to a network or many clients connected to a network. Moreover, embodiments in accordance with the described systems and methods also include a multitude of clients throughout the world connected to a network, where the network is a wide area network, such as the Internet. Accordingly, in some embodiments, the described systems and methods can allow for remote monitoring, observation, adjusting, and other controlling of one or more of the described systems 10 from many places throughout the world.

The present invention may be embodied in other specific forms without departing from its spirit or essential characteristics. The described embodiments, examples, and illustrations are to be considered in all respects only as illustrative and not restrictive. The scope of the invention is, therefore, indicated by the appended claims rather than by the foregoing description. All changes that come within the meaning and range of equivalency of the claims are to be embraced within their scope. In addition, as the terms on, disposed on, attached to, connected to, coupled to, etc. are used herein, one object (e.g., a material, element, structure, member, etc.) can be on, disposed on, attached to, connected to, or coupled to another object—regardless of whether the one object is directly on, attached, connected, or coupled to the other object, or whether there are one or more intervening objects between the one object and the other object. Also, directions (e.g., front back, on top of, below, above, top, bottom, side, up, down, under, over, upper, lower, lateral, etc.), if provided, are relative and provided solely by way of example and for ease of illustration and discussion and not by way of limitation. Where reference is made to a list of elements (e.g., elements a, b, c), such reference is intended to include any one of the listed elements by itself, any combination of less than all of the listed elements, and/or a combination of all of the listed elements. Furthermore, as used herein, the terms a, an, and one may each be interchangeable with the terms at least one and one or more.

What is claimed is:

1. A hydration system comprising:
a fluid container;
a mister nozzle in fluid communication with the fluid container;
a pressurizer configured to force fluid from the fluid container to the mister nozzle; and
a control mechanism that is configured to vary a rate at which the pressurizer forces fluid from the fluid container to the mister nozzle,
wherein the control mechanism is configured to increase a rate at which the pressurizer forces fluid from the fluid container to the mister nozzle, based on an ambient temperature.
